(19) United States
(12) Patent Application Publication
(10) Pub. No.: US 2007/0164528 A1
(43) Pub. Date: Jul. 19, 2007

(54) Wheeled walking frame

(76) Inventor: Frank Morath, Villingen-Schwenningen (DE)

Correspondence Address: DREISS, FUHLENDORF, STEIMLE & BECKER, POSTFACH 10 37 62, D-70032 STUTTGART, DE

(21) Appl. No.: 10/583,545

(22) PCT Filed: Dec. 14, 2004
(86) PCT No.: PCT/EP04/14223

§ 371 Date: Jun. 19, 2006

(30) Foreign Application Priority Data
Dec. 19, 2003 (DE) 203 19 851.4
Apr. 23, 2004 (DE) 10 2004 020 989.8

(51) Int. Cl. B62M 1/00

(52) U.S. Cl. 280/87.05

(57) ABSTRACT

A wheeled walking frame (2) comprises a stand (4) provided with front wheels (16, 18), rear wheels (20, 22) and at least two grip parts (8, 10) for pushing the walking frame (2) in the walking direction (6). The grip parts (8, 10) can pivot out of a main position (I), in which they are essentially parallel to the walking direction (6), into a pivoted position (II) in which they are arranged essentially transversely to the walking direction (6).

The invention concerns a walker with a frame on which front wheels and rear wheels as well as at least two gripping members are disposed for displacement of the walker in a walking direction.

Walkers have been designated as “rollators”. They comprise a displaceable frame upon which a person can support himself to simplify the walking procedure. A walker is used as mobility assistance for older individuals or to simplify the recuperative phase of a patient following an injury, in particular, in the leg or foot region.

A walker of the above mentioned kind is e.g. known in the art from EP 0729737. The walker disclosed therein comprises a tubular frame having two displacement rods each of which has a handle on the end facing away from the support surface of the walker. A person can support himself using these gripping members so that a portion of the bodily weight of the torso of the individual is supported and the entire weight does not load the legs or feet of the individual.

The walker disclosed in EP 729737B1 has the disadvantage that it can only be handled in a satisfactory fashion when the walker is used for walking assistance. In the event that the conventional walker is to be stored or used as a transport mechanism, the maneuvering of the walker is relatively cumbersome.

Departing there from, it is the underlying purpose of the present invention to create a walker with improved handling properties.

This purpose is achieved with a walker having the features of claim 1.

When the gripping members are disposed on the main support, an individual can easily support himself thereon and the walking procedure is simplified. When the gripping members are located in their pivoted position, it is easier to displace the walker in a forward direction (the walking direction) compared to the walkers of prior art. Moreover, in contrast to the walkers of prior art, the disposition of the gripping members in accordance with the invention also facilitates pulling the walker behind the individual so that maneuverability of the walker is substantially improved. It is therefore easier to store the walker in a niche or in a corner of a room without difficult handling, for example, lifting of the walker. Moreover, utilization of the walker as a transport device is substantially improved, in particular, when the walker is to be put into a suitable position for loading or carrying shopping goods.

In accordance with the invention, the gripping members are slightly separated from or even contact each other in the pivoted position. This has the advantage of providing a grasp in the vicinity of the mutually facing gripping members which is located in the middle of the walker. In this fashion, the walker can be easily displaced in the walking direction even if operated with one hand or can be pulled behind the walking direction without having the walker drifting in a sideward direction, thereby requiring a directional correction. The central grip is particularly advantageous when the gripping members touch each other.

In an advantageous embodiment of the invention, the gripping members can be locked relative to the frame in the main as well as in the pivoted position. The locking can thereby, in particular, be effected on the frame. It is thereby possible to guarantee that the gripping members reliably remain in position. An appropriate lock can e.g. be effected by a snapping mechanism. Locking of the gripping members in the pivoted position has the advantage of providing a grip in the vicinity of the mutually facing gripping members which is located in the middle of the walker. In particular when used with a single hand, it is thereby easier to push the walker in the walking direction or pull the walker behind the walking direction, without having the walker drift towards the side and require a directional correction. The central grip is particularly advantageous when the gripping members touch each other.

The gripping members can furthermore advantageously be locked relative to the frame in an intermediate position. In this manner, the gripping members can not only be locked in a substantially parallel direction relative to the walking direction as well as perpendicular thereto rather also in any arbitrary pivotable position. This permits adjustment of the walker to the user in an ergonomically optimal sense. By way of example, the gripping members can be oriented to be slightly diagonal with respect to the walking direction. The position of the gripping members can thereby be optimally oriented for natural disposition of the hands and arms of a supported person.

In accordance with the invention, the gripping members advantageously have a locking section on each of their free ends which is configured in such a fashion that, in the pivoted position, the two locking sections are positioned opposite each other and can be locked together, at least in sections, using a locking element which engages at least portions of both locking sections. The provision of locking sections on the free ends of the gripping members and provision of the corresponding locking elements facilitates a secure locking of the two gripping members in their pivoted position in an effective and straight forward fashion. The gripping members which are thereby locked to each other cannot move relative to each other or can only move relative to each other to a very limited extent. This results in an overall stable connection between the gripping members. If the gripping members can be locked to each other in their pivoted position, a further locking of the gripping members to the frame is obviated.

In their pivoted position, the gripping members can cooperate to form a bracket type handle. This leads to a particular advantageous ergonomics for the gripping region in the middle of the walker. The bracket-shaped grip can have curved or linear travel.

In accordance with an advantageous configuration of the invention, the locking sections on each of the gripping members touch each other in the pivoted position at least in sections. The contact between the two locking sections or a mutual seating on the locking sections can be advantageously effected in a positive fit fashion. Towards this end an appropriate configuration of the locking sections or of the seating surfaces of locking sections can lead to additional stabilization of a connection between the two gripping members.

The locking sections advantageously have at least sections which are substantially perpendicular to the pivot axis of the two gripping members and configured as seating surfaces. The two pivot axes thereby advantageously extend parallel to each other. This guarantees that the seating surfaces of the locking sections of the two gripping members are disposed opposite to each other or form an appropriate positive connection when the two gripping members are pivoted into the pivoted position.

The term “seating surface” in accordance with the invention is defined to be flat, curved, or a surface of any arbitrary shape. By way of example, the seating surfaces may have grooves, channels, elevations or the like.

In a particularly preferred embodiment of the invention, the locking element is disposed on a gripping portion under spring tension in such a fashion that it engages through the seating surface of this gripping member, wherein the locking element can be at least partially or substantially pushed into the grip in opposition to this spring tension. The captured configuration of the locking element on the gripping member prevents the locking element from being separated and lost. The resilient spring tension keeps the locking element in the position in which the locking is effected. The locking element is pushed into the unlocked position in opposition to the pretension to release the lock.

The gripping member on which the locking element is not disposed advantageously has a locking receptacle for at least partial engagement of the locking element in the locked position. The locking receptacle is thereby advantageously only slightly larger than the locking element as a result of which, a locking of the two locking elements is facilitated substantially without play. The locking receptacle can e.g. be an opening or a bore.

A further advantageous configuration of the invention is distinguished in that the gripping member having the locking receptacle has a switchable release element with which the locking element can be brought out of the locked position into an unlocked position in opposition to the spring tension. The release element is advantageously disposed in such a fashion as to be accessible to the person pushing or pulling the walker in a simple, straight forward fashion.

Towards this end, the releasing element can be captured and disposed under pretension on the gripping member in such a fashion that the spring tension holds same in a position which can be easily accessed, wherein, in the locked position, pressure on the release element in opposition to the resilient spring force acting on the release element brings the locking element out of the locking position into an unlocked position.

The releasing element is preferentially disposed on the gripping member or locking section in such a fashion that it is captured and at least partially penetrates into the locking receptacle in the unlocked position to displace the locking element disposed in the locking position out of that locking receptacle.

In the unlocked position, the locking element is consequently pushed out of the locking receptacle by the releasing element to a sufficient extent as to permit a pivoting of the gripping member out of the grip position into the main position. The locking element is thereby disposed on the locking section of one gripping member and the locking receptacle is disposed together with the release element on the locking section of the other gripping member.

In the locked position, the locking element, at least portions of which engage into the locking receptacle, and the release element are advantageously disposed along a line, one behind the other, the line being substantially parallel to the pivot axis of the gripping member and/or perpendicular to the seating surface of the gripping member.

The locking element can thereby be configured as a locking bolt and/or the release element can be configured as a releasing bolt. The locking element is then disposed along its longitudinal axis in the locking section of one gripping member in a displaceable fashion. The releasing element is then disposed in the locking section of the other gripping member along its longitudinal axis to be likewise displaceable along that axis.

In an additional embodiment of the invention, the locking section having the locking receptacle has an introductory bevel configured in such a fashion that when the locking element is pivoted into the locking position the locking element is pushed by the introductory bevel in opposition to the spring tension, into the gripping member before it snaps into the locking receptacle of the other gripping member in consequence of the spring tension. The introductory bevel thereby guarantees that a pivoting of the gripping member into the pivoting position in not hindered or prevented by the locking element. The locking element is pushed into the locking section in opposition to the spring tension with which it is disposed before it can be snapped into the locking receptacle of the other locking section in response to that spring tension.

The locking section which does not have an introductory bevel thereby advantageously has a configuration which is complementary to the introductory bevel in such a fashion that the two locking sections substantially form a closed surface in the locked state. In this fashion, the two locking members can be easily grasped in the locked state by the person using the walker by pulling or pushing same. The corresponding maneuvering of the walker can then be carried out in a simple fashion.

In accordance with the invention, the locking sections can be integral with the gripping members. The gripping members, in and of themselves, may advantageously also be made from a metallic material, and the locking sections from another material, in particular, plastic. The locking sections can e.g. be foamed onto the metallic gripping members.

Taken together, the gripping members can form a common bracket grip in the pivoted position. This leads to an particular advantageous ergonomics for the middle region of the walker. The bracket shaped grip can have a curvature or be substantially straight.

The ergonomics of the walker in accordance with the invention can be further improved when the gripping member has a height which can be displaced relative to the frame. In this fashion, the walker can be adjusted in an optimal fashion to people of different heights. The height displacability of the gripping members can e.g. be configured in a continuous fashion with the assistance of a clamping mechanism or in steps with the assistance of a snap mechanism.

It is furthermore advantageous for ergonomic reasons as well as for reasons of good handling of the walker, when the front wheels and the rear wheels are displaced relative to each other perpendicular to the walking direction. This means that the rear wheels do not follow in the tracks of the front wheels, rather form their own tracks. This has the advantage that the seating surface of the walker is increased and the stability with respect to tilting increases. Moreover, the front and rear wheels cannot simultaneously enter into a depression in the seating surface of the walker. For example, one thereby avoids the possibility of both the front and rear wheels fall into a street car track, since they are displaced relative to each other.

The frame preferably has two support tubes on which or in which the grip members are borne. In this manner receptacles can be formed for the gripping member using components of the frame. A displacing section of the gripping members can recede into the support tubes and be fixed therein. The support tubes are preferably made from a light material such as aluminum.

The front wheels can be disposed on front frame members, wherein the front frame members are preferably formed by the support tubes. Towards this end, the support tubes can have receptacles for the gripping members at one end thereof and the other end can fashion a support or seating for bearing the front wheels. The parts which are necessary to assemble the walker are thereby substantially reduced.

It is furthermore very advantageous for the rear wheels to be disposed on rear frame members which can be pivoted out of a use position into a storage position. The walker can support a user in the use position described above. When the rear frame portions are pivoted into a storage position, the walker assumes a smaller amount of space so that the storage or transport of the walker, e.g. in a trunk of a vehicle, is simplified. The pivoting of the rear frame member into a storage position proximate the front wheels also has, however, the advantage that the walker cannot only be used as such rather also as a single axis transport device i.e. a “trolley”. Towards this end the walker, recast in its function into a trolley, can e.g. be rolled with the rear wheels, wherein the front wheels avoid contact with the ground and with the support surface of the walker.

It is, however, also possible that the rear wheels in a rear part of the frame are separated from a support surface of the walker. In this configuration the walker which has been recast in its function to be a trolley can be moved through contact between the front wheels and the support surface.

It is also possible that the front wheels and the rear wheels and/or their axes of rotation can be brought into an aligned position. This assumes that the front wheels and the rear wheels are displaced with respect to each other, wherein the front wheels and the rear wheels form a single axis transport device in their aligned position. This functions like a trolley and rolls with rotational axes which are aligned using rear and front wheels which have the same size, however, with four wheels rather than two.

In the event that the front wheels have a smaller or a larger diameter than the rear wheels, when the axes of the front and the rear wheel position are aligned and the walker is in the trolley position, the transport nevertheless occurs using two wheels only.

The front frame portion and the rear frame portion can be connected to each other by means of at least one intermediate element. This can improve the stability of the walker and/or serve as a spacer between the frame members.

At least one seat is advantageously provided. This allows for a resting position for the person using the walker. It is also possible for an additional person, e.g. a small child, to sit on the seating portion.

The seating member can also be used as a simple seating surface. The seating surface can support itself on an intermediate element in a substantially horizontal use position. This has the advantage that the seating member is closed to the center of gravity so that the walker can also be used by relatively heavy person without tilting.

The seating portion can advantageously be brought from a use position into a storage position. This reduces the amount of space needed to store the walker.

A further advantageous configuration of the invention, the walker has a transport container. This is advantageously attached to the walker in a detachable fashion. Towards this end, the packing or unpacking of the transport container does not take place on the walker itself rather can be carried out in a separate location.

Further advantageous configurations and details of the invention can be extracted from the following description in which embodiments of the invention are described and explained more closely with reference to the drawing.

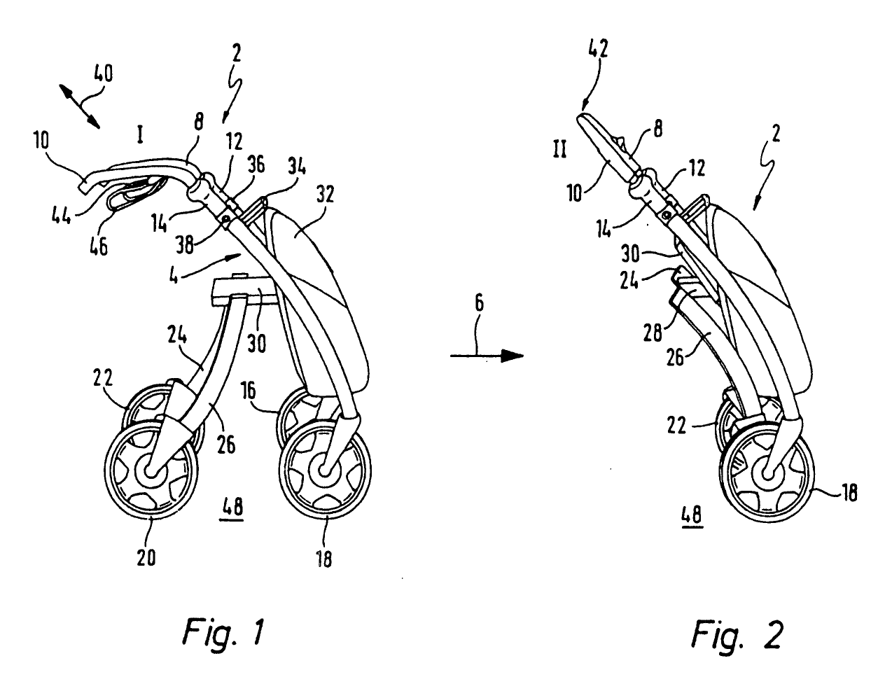

FIG. 1 shows a side view of the first embodiment of a walker in accordance with the invention;

FIG. 2 shows a side view of a walker in accordance with FIG. 1, transformed in terms of function into a trolley;

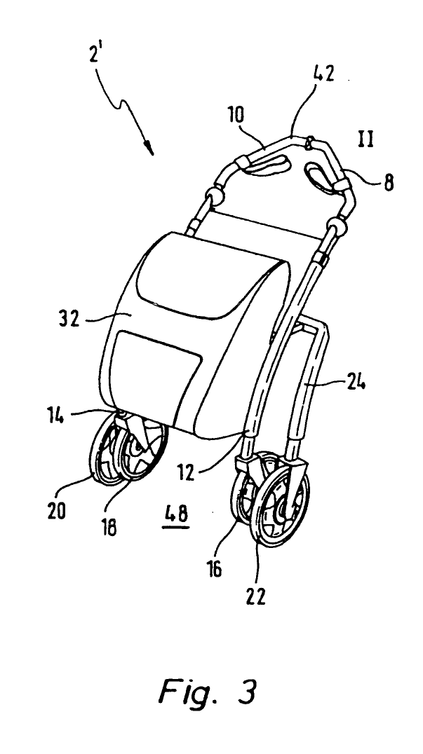

FIG. 3 shows a perspective view of a second embodiment of a walker in accordance with the invention;

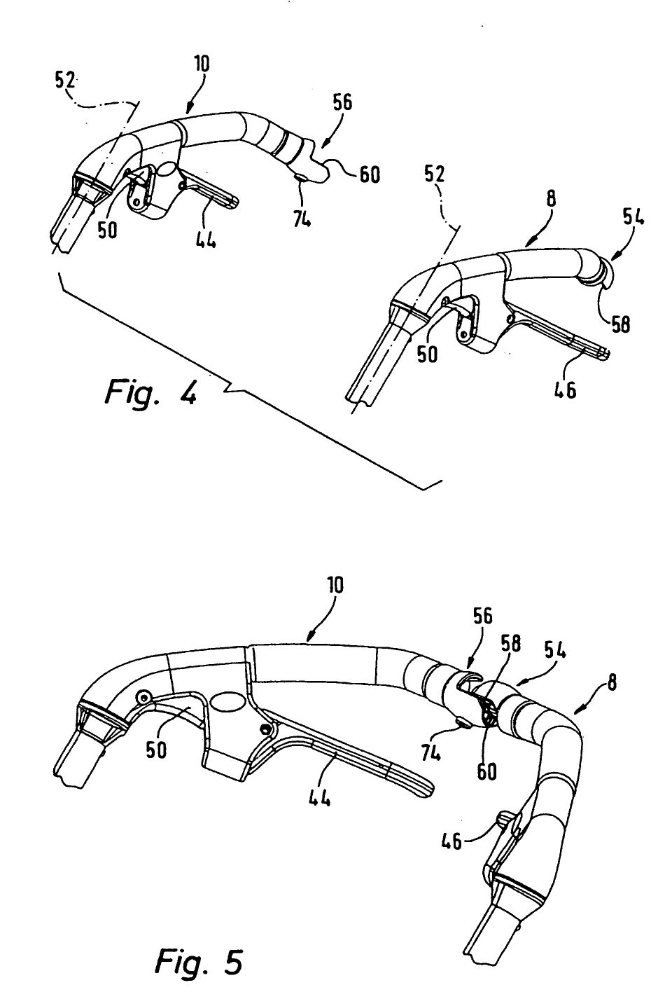

FIG. 4 shows a perspective view of a gripping member of the walker in the principle position;

FIG. 5 shows the gripping member according to FIG. 4 shortly before achieving the pivoted position;

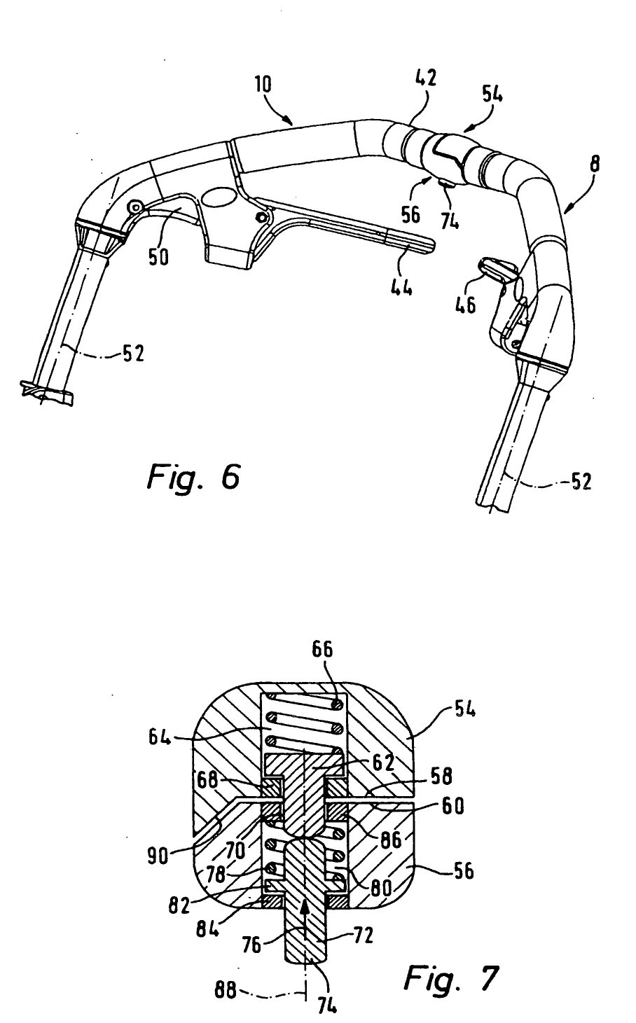

FIG. 6 shows the gripping member in accordance with FIG. 5 in the pivoted position;

FIG. 7 shows a cross-section through gripping members locked to each other;

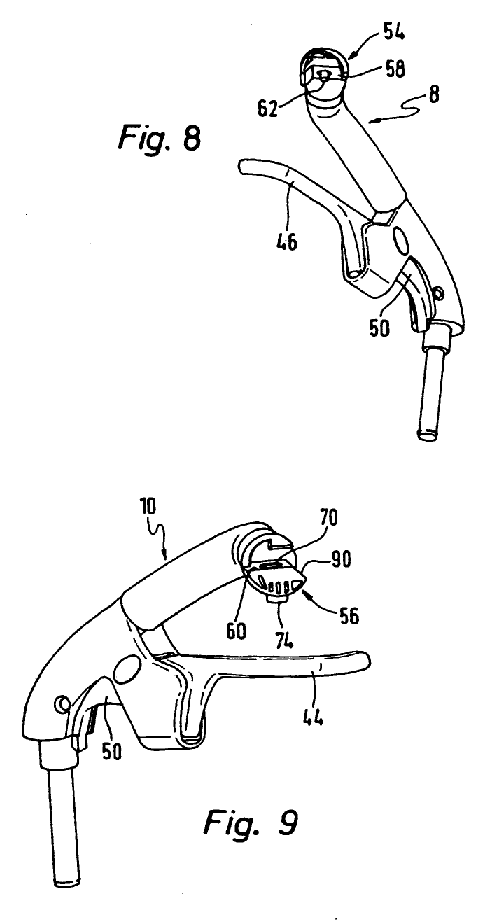

FIG. 8 shows a perspective view of the gripping member 8; and

FIG. 9 shows a perspective view of the gripping member 10.

FIG. 1 shows the walker indicated in its entirety with reference symbol 2. The walker consists essentially of a frame 4 which can be displaced in a walking direction 6. A left gripping member 8 as well as a right gripping member 10 are disposed on the frame 4. A person can support himself on the walker 2 using the gripping members 8 and 10.

The frame 4 has a front frame member 12 and 14 forming receptacles for the gripping members 8 and 10 on ends facing the gripping members 8 and 10 and has a bearing support for the front wheels 16 and 18 on the other ends facing away from the gripping members 8 and 10. The rear wheels 20 and 22 of the walker 2 are borne on rear frame portions 24 and 26. The rear frame portions 24 and 26 are borne in a pivotable fashion on an intermediate element 28 which is firmly connected to the front frame members 12 and 14. The intermediate element 28 is shown in FIG. 2 and is covered in FIG. 1 by a seating member 30 which is shown in the substantially horizontal, use position.

A forward end of the seating member 30 (towards the walking direction) is adjacent to the back wall of a transport container 32 which is disposed on the frame portions 12 and 14 in a detachable manner using a bracket 34. The frame members 12 and 14 have locking elements 36 and 38 on their upper end facing the gripping members 8 and 10. When these locking elements are released, the height of the gripping members 8 and 10 can be adjusted in the adjustment direction 40. The gripping members are shown in FIG. 1 in a main position labeled “I” and are substantially parallel to the walking direction 6. They can, however, be brought into a pivot position “II” as shown in FIGS. 2 and 3. In this pivot position, the gripping members 8 and 10 are substantially perpendicular to the walking direction 6 and form, in their totality, a bracket shaped grip 42 (see FIGS. 3 and 6). With the assistance of the bracket shaped grip 42, the walker 2 can be pulled or pushed in the walking direction 6.

Brake operating elements 44 and 46 are disposed on the gripping elements 8 and 10 and can be operated in both the main position I as well as in the pivoted position II. Towards this end, the walker 2 can be securely arrested relative to a support surface 48.

In accordance with FIG. 2, the walker 2 has been transformed with regard to its function into a trolley. Towards this end, the rear frame portions 24 and 26 are pivoted out of the position shown in FIG. 1 into the position shown in FIG. 2. In the position of FIG. 2, the rear frame portions 24 and 26 are substantially parallel to the front frame portions 12 and 14.

The rear wheels 20 and 22 have a smaller track width than the front wheels 16 and 18. In this manner, the rear wheels 20 and 22 can be accepted in intermediate spaces defined by the front wheels 16 and 18 in an aligned configuration when the rear wheels 26 and 28 are disposed in the “trolley position” of the walker 2 and proximate the front frame portions 12 and 14.

The walker 2′ in accordance with FIG. 3 is likewise shown in the “trolley position”. The two gripping members 8 and 10 form an ergonomically convenient bracket shaped grip 42 by means of which the walker 2′ can be pushed or pulled. The free ends of the two grips 8 and 10 touch each other and are locked to each other. In accordance with the invention, the free ends of the two gripping portions 8 and 12 can face each other, or in contrast to the representation of FIG. 3, can be slightly separated from each other.

The walker 2′ in accordance with FIG. 3 is distinguished from the walker 2 in accordance with FIGS. 1 and 2 in that the track width of its rear wheels 20 and 20 is larger than the track width of the front wheels 16 and 18. In this fashion, the front wheels 16 and 18 and the front frame portions 12 and 14 can be accepted in intermediate spaces defined by the rear wheels 20 and 22 and the rear frame portions 24 and 26 (covered by transport container 32).

The rear wheels 20 and 22 seat on a support surface 48 whereas the front wheels 16 and 18 are separated from that support surface 48.

FIG. 4 shows the two gripping members 8 and 10 in the principle position. The gripping members 8 and 10 are preferentially locked to the frame in this main position. The gripping members 8 and 10 have an unlocking bracket 50 to release the lockage. Bracket shaped brake operating elements 44 and 46 are also shown in FIGS. 4 through 6 as well as 8 and 9. Operation of the release bracket 50 can cause the grip members 8 and 10 to be pivoted about their respective pivot axes 52 into the pivot position shown in FIG. 6.

Locking sections 54 and 56 are provided on the free ends of the gripping members 8 and 10 by means of which the free ends of the pivot bracket 8 and 10 can be locked to each other. The two locking sections 54 and 56 each have a seating surface 58 and 60. In the locked position, both seating surfaces 58 and 60 face each other and are positioned opposite to each other. The seating surfaces 58 and 60 are particularly clear in FIG. 7. The seating surfaces 58, 60 can be flat surfaces (see FIG. 7). However, in accordance with the invention, the seating surface can also be curved surfaces or have a non-flat structure. The gripping member 8, in particular the locking section 54 of the gripping member, has a locking element 62 for locking the two locking sections 54, 56 which, in the locking position shown in FIG. 7, penetrates through the two seating surfaces 58 and 60 in such a fashion as to prevent the two gripping members 8 and 10 from pivoting out of the gripping position shown in FIG. 6.

The two seating surfaces 58 and 60 are preferentially configured in such a fashion that they seat with positive connection on each other in the pivoted position of the gripper members 8 and 10.

The seating surfaces 58 and 60 can, in particular, extend in such a fashion that they are at least substantially perpendicular to the pivot axis 52 and the gripping members 8 and 10.

As can clearly be seen in FIG. 7, the bolt like locking elements 62 of the locking section 54 is captured in a preferentially cylindrically configured receptacle 64. The receptacle 64 can e.g. be configured as a blind hole or as a through hole. The locking element 62 is pretentioned by a spring element 66 to such an extent that the free end of the locking element penetrates through the seating surface 58 of the locking section 54. The locking element 62 is thereby captured in the T-shaped section shown in FIG. 7 and is held by a ring 68 fashioned in the locking section 54.

In that locking position, the free end of a locking element 62 engages into a locking receptacle 70 on the locking section 56. The locking receptacle 70 has a diameter which is slightly larger than the free end of the locking element 62 so that the two locking sections 54 and 56 can be locked to each other by means of the locking element 62, substantially without play.

The locking section 56 comprises a release element 72 which can be activated, one end of which 74 protrudes out of the locking section 56 for activation and the other end of which faces the free end of the locking element 62. When the release element 72 is pushed in the operative direction 76, the locking element 62 can be brought out of the locking position and into an unlocked position in opposition to the spring tension of the spring element 62. Towards this end, the locking element 62 is at least substantially completely withdrawn into the receptacle 64 of the locking section 54.

As clearly shown in FIG. 7, the bolt like release element 72 is disposed on the grip member 10 or on the locking section 56 under pretension produced by the resilient elements 78 and thereby held in a position accessible to an operator. Towards this end, the releasing element 72 is disposed in a receptacle 80 in axial extension of the locking element 62 and of the locking receptacle 70. The releasing element 72 has a ring-shaped band 82 one end of which is subjected to loading by the spring elements 78 and the other end of which is supported on a ring 84 fashioned in the locking section 56. The resilient element 78 is likewise supported in the region of the locking receptacle 70 on a ring 86 fashioned in the locking section 56.

As already mentioned, the locking element 62 and the releasing element 72 are disposed along a common axis 88. The axis 88 is preferentially parallel to the pivot axis 52.

In order to release the two gripping members 8 and 10, the releasing elements 78 is pushed in the direction of arrow 76 in opposition to the spring tension of the two spring elements 66 and 78. The locking element 62 thereby moves into the receptacle 64. The unlocked position is achieved when the locking element 62 is substantially completely withdrawn into the receptacle 64. The two gripping members 8 and 10 can then be pivoted about their pivoted axis 52 out of the locking position into the main position.

The facing ends of the locking elements 62 and of the release element 72 can advantageously have surfaces which are spherical in shape. Towards this end, it is easier to pivot the two gripping members 8 and 10 out of the pivoted position into the main position.

FIG. 7 also clearly shows that the locking section 54 has an introductory bevel 90 which is configured in such a fashion that, in the event that the gripping members 8 and 10 are pivoted into the pivot position the introductory bevel 90 pushes the locking element 62 into the receptacle 64 of the locking section 54 in opposition to the pretension of the spring element 66. When the locked position has been reached, the locking element 62 snaps into the locked receptacle 70.

The locking section 54 has a shape which is complementary to the introductory bevel such that the two locking sections 54, 56 substantially form a closed surface in the locked position. The locking sections 54 and 56 face each other and are therefore configured in a complementary fashion so that they seat substantially in positive engagement in each other in the locked position.

The gripping members 8 and 10 shown in the pivoted position in FIG. 6 are advantageously locked to each other on the free ends of the gripping members 8 and 10 by means of the locking elements 62. An additional locking about the pivot axis 52 is provided for on the frame. This additional locking can be released by the unlocking bracket 50.

The free ends of the grips 8 and 10 having the corresponding locking sections 54 and 56 are shown in FIGS. 8 and 9. The locking elements 62 which is raised above the seating surface 58, can be clearly seen in FIG. 8.

FIG. 9 clearly shows the seating surface 60 with the locking receptacle 70. Moreover, the introductory bevel 90 is also shown which pushes the locking element into the grip member 8 or into the locking section 54 when the gripping member is pivoted into the pivoting position.

1-18. (canceled)

19. A walker comprising:
a frame;
front wheels mounted to said frame;
rear wheels mounted to said frame;
a first gripping member mounted to said frame; and
a second gripping member mounted to said frame, wherein
said first and said second gripping members are disposed for displacing the walker in a walking direction, said first and second gripping members being structured to assume a first position in which they are substantially parallel to said walking direction and to pivot into a second position in which they are substantially transverse to said walking direction, wherein ends of said gripping members cooperate or are proximate to each another in said second position.

20. The walker of claim 19, wherein said first and second gripping members can be locked in said first position, in said second position, and/or in intermediate positions.

21. The walker of claim 19, wherein each of said first and said second gripping members has a locking section in a region of a free end thereof, which is configured in such a fashion that, in said second position, said locking sections have members which face each other and which can be locked to each other by means of a locking element, said locking element engaging in at least portions of said locking sections.

22. The walker of claim 21, wherein said locking sections have seating surfaces which cooperate with another in said second position.

23. The walker of claim 21, wherein said locking sections define seating surfaces which are substantially perpendicular to a pivot axis of said first and second gripping members.

24. The walker of claim 22, wherein said locking element is captured in one of said locking sections and is disposed under spring tension in such a fashion as to project beyond said seating surface of one said locking section, wherein said spring tension urges said locking element out of said one locking section.

25. The walker of claim 24, wherein a locking section in which said locking element is not disposed has a locking receptacle for at least partial engagement of said locking element in a locked position thereof.

26. The walker of claim 25, wherein said locking section having said locking receptacle has a releasing element with which said locking element can be displaced, in opposition to said spring tension, out of said locked position into an unlocked position.

27. The walker of claim 26, wherein said locking element is captured in said locking section and is spring loaded against said releasing element, wherein application of pressure by a user against said releasing element moves said locking element out of said locked position into said unlocked position.

28. The walker of claim 26, wherein said locking element and said releasing element are collinearly disposed in said locked position and are substantially parallel to a pivot axis of said gripping members and/or perpendicular to said seating surfaces of said locking sections.

29. The walker of claim 26, wherein said locking element is configured as a locking bolt and/or said releasing element is configured as a releasing bolt.

30. The walker of claim 26, wherein said locking section having said locking receptacle has an introductory bevel configured to displace said locking element in opposition to pretension and into said locking section when said first and said second gripping members are pivoted into said second position and prior to a point in time in which said locking element snaps into said locking receptacle in response to spring pretension.

31. The walker of claim 30, wherein said locking section which does not have an introductory bevel has a shape which is complementary to that of said introductory bevel such that said first and said second gripping members substantially form a closed surface in a locked state thereof.

32. The walker of claim 19, wherein said front wheels and said rear wheels are offset relative to each other, perpendicular to the walking direction.

33. The walker of claim 19, wherein said front wheels are disposed on front frame portions and said rear wheels are disposed on rear frame portions, wherein said rear frame portions can be pivoted from a use position into a storage position proximate to said front wheels, wherein either said rear wheels are separated from a support surface of the walker in said storage position of said rear frame portion, or said front wheels are separated from a support surface of the walker in said storage position of said rear frame portions.

34. The walker of claim 19, wherein said front wheels said rear wheels and/or axes of rotation thereof can be brought into mutual alignment, wherein a diameter of said front wheels can differ from a diameter of said rear wheels.

35. The walker of claim 19, wherein a seat member is disposed and supported on an intermediate element in a substantially horizontal use position and structured for displacement out of said use position into a storage position.

36. The walker of claim 19, wherein the walker has a transport container.
